(19) United States
(12) Patent Application Publication
(10) Pub. No.: US 2006/0041333 A1
(43) Pub. Date: Feb. 23, 2006

(54) Robot

(76) Inventor: Takashi Anezaki, Hirakata-shi (JP)

Correspondence Address: WENDEROTH, LIND & PONACK L.L.P., 2033 K. STREET, NW, SUITE 800, WASHINGTON, DC, 20006, US

(21) Appl. No.: 11/129,324

(22) Filed: May 16, 2005

(30) Foreign Application Priority Data
May 17, 2004 (JP) 2004-145739

(51) Int. Cl. G06F 19/00

(52) U.S. Cl. 700/259; 700/245

(57) ABSTRACT

There are included a surrounding pattern projection system for projecting an annular pattern light beam encircling a main unit portion from an upper side of the main unit portion to a floor surface around the main unit portion in an oblique direction with respect to the floor surface, a camera for picking up a projected pattern image of the pattern light beam projected from the surrounding pattern projection system from the upper side of the main unit portion, and a image processing device for sensing a displacement of the projected image of the pattern light beam based on the picked up image picked up by the camera, the displacement being generated when the pattern light beam is projected onto a portion of an obstacle around the main unit portion which is different in height from the floor surface, and for detecting thereby the obstacle around the main unit portion.

### BACKGROUND OF THE INVENTION

The present invention relates to a robot capable of detecting the presence of obstacles in the surrounding region, a transportation method for transporting a transportation target by using the robot, and a guiding method for guiding a guiding target to a destination by using the robot.

Several methods have been proposed in the past for recognizing objects and measuring the three-dimensional shapes of the objects. For example, Patent Document 1 (U.S. Pat. No. 2,559,443). discloses a measurement method using the principle of triangulation and a measurement method involving a projection method. Hereinbelow, description will be given of these examples with reference to FIG. 8 to FIG. 12.

First, the principle of triangulation is shown in FIG. 8. As shown in FIG. 8, when, in a triangle ABC, a camera is placed in a node (point) Na, a target of measurement is placed in a node Nb, and a camera is placed in a node Nc, images of the target can be picked up by the cameras placed in the nodes Na and Nc, and from the images obtained, positional information (x,y) of the target on the images can be obtained. However, from these images, positional information (z component) of the target in its depth direction cannot be obtained.

Accordingly, if directions θX and θ0 from the node Na and the node Nc to the node Nb are found, and a distance between the node Na and the node Nc is set to be L, then from these values, a distance between the node Na and the node Nb and a distance between the node Nb and the node Nc can be calculated, respectively. Therefore, from the images, the positional information (z component) of the target in the depth direction, i.e., a distance D between a midpoint Nh between the nodes Na and Nc and the node Nb can be calculated as shown below:
D=L/(cot θₒ+cot θₓ)

A method for measuring a distance to a measurement target based on the above-described principle of triangulation is shown in FIG. 9. It is to be noted that the method is called binocular vision method.

In FIG. 9, nodes F1 and F2 are the centers of camera lenses, and their three dimensional positions are known in advance. Now, an image of a point P on a measurement target is picked up by the respective cameras, and if the position of the point P appears in the position of a point P1 in a left-side screen C1, while the position of the point P appears in the position of a point P3 in a right-side screen C2, then the three dimensional position of the point P can be obtained as an intersection point of two straight lines F1P1 and F2P3.

However, in such a measuring method, unless it is known that the position of the point 1 in the left-side screen corresponds to the position of the point P3 in the right-side screen, the position of the point p cannot be measured. Making the points in the screens C1 and C2 correspond to each other is called corresponding point detection, and a general and reliable method for the corresponding point detection has not yet established.

Description is now given of a measurement method called projection method which does not need the corresponding point detection, with reference to FIG. 10 and FIG. 11.

As shown in FIG. 10, spot light 22 coming from a projector 20 is reflected by a mirror 25 so as to be projected onto one point P of an object 21, and reflection light 23 coming from the object 21 is received by a sensor 24, by which distance information on the three dimensional position of the point p is found from the principle of triangulation. Therefore, in the projection method, the problem of the corresponding point detection does not arouse. Since the beam of the spot light 22 should preferably be focused as much as possible, a laser is used as a light source of the projector 20. Moreover, as the sensor 24, a semiconductor PSD (Position Sensitive Device) for outputting the two dimensional position of a luminescent spot is widely used.

In order to obtain distance information on a number of points in this measurement method, a mirror 25 should be disposed in an optical path of the spot light 22 and rotated to change the direction of the spot light 22, and every time the direction is changed, it is only necessary to recalculate the distance information.

However, in such a measurement method, a measurement time is limited by a rotation time of the mirror 25. More particularly, the measurement takes long time.

A measurement method using a pattern projection method that is different from the projection method shown in FIG. 10 is shown in FIG. 11.

As shown in FIG. 11, pattern light 31 is projected onto a measurement target 32 from a projector 30 having a projection center S, and a reflected image from the measurement target 32 is picked up by a TV camera 33 having a lens center F. Reference numeral 34 denotes a pattern member of the projector 30 having a slit 34a for forming the pattern light 31, and reference numeral 35 denotes a TV screen.

With this configuration, if a point P on the measurement target 32 appears in the position of a point P1 in the slit 34a of the pattern member 34 and appears in the position of a point P2 in the TV screen 35, then the position of the point P can be obtained as an intersection point between straight lines SP1 and FP2. Moreover, in order to obtain distance information on a number of points, the projector 30 is rotated, and in every rotation, an image projected onto the measurement target 32 is picked up by the TV camera 33, and distance information is preferably calculated. Thus, by using the pattern light 31 as shown in FIG. 11 instead of the spot light 22 shown in FIG. 10, the number of points measurable in one image pickup is considerably increased.

It is to be noted that, for example, Patent Documents 2 to 4 (Japanese Unexamined Patent Publication No. S63-5247, Japanese Unexamined Patent Publication No. S62-228106, Japanese Unexamined Utility Model Publication No. S63-181947) disclose a technique for non-contact three dimensional measurement of an object with use of the technique of three dimensional measurement.

In the above description, the techniques to measure and recognize the three dimensional position of an object have been described, which indicated that a reliable method for binocular corresponding point detection has not yet established for the binocular vision method as shown in FIG. 9, and this causes an issue.

Moreover, while the projection methods shown in FIG. 10 and FIG. 11 makes it possible to identify projected light spots on the image and therefore does not essentially require the corresponding point detection, these methods still have the issue that unless a light spot or pattern light is expanded over the entire surface of a target, the three dimensional information on the target cannot be obtained. Consequently, in the case where, for example, 200 pattern light beams are thrown in sequence to the surface of a target for expanding a light spot or pattern light on the entire surface of the target, image pick-up by the TV camera need to be conducted 200 times.

As a solution for this issue, projecting parallel pattern light or throwing cross stripes pattern light are considered, but these methods have an issue of corresponding point determination as in the case of the binocular vision method, and it is also necessary to distinguish (identify) respective pattern light beams to avoid confusion of the beams.

To settle the issue, a method for coding pattern light beams so as to distinguish each pattern light beam has been proposed. The coding method involves coding with use of the width of pattern light beams as well as use of a plurality of pattern images in chronological order. However, when the coding projection method is used in actuality for three dimensional measurement, light projection and image input speed in manufacturing lines, for example, is higher the better, and reflection conditions of various pattern light beams are determined by targets, which makes it necessary to change the pattern light beams to vertical, horizontal, and oblique beams arbitrarily in real time depending on the targets.

Under these circumstances, as shown in FIG. 12, there is a method comprising the steps of concurrently forming a plurality of pattern light beams, projecting a plurality of pattern light beams 43 each having an appended code and having arbitrary shapes to a measurement target 41 or a floor surface 42 with use of a dot matrix-type electro-optical shutter 40 which can append information for distinguishing each pattern light beam to each pattern light beam, picking up projected images by a TV camera 44, and applying image processing to the picked-up images by an image processing device 45 so as to achieve three dimensional measurement of the measurement target 41. It is to be noted that the dot matrix-type electro-optical shutter is the shutter in which each pixel is normally in a transparent state and when specified pixels carry current, these pixels become opaque. More particularly, selecting pixels carrying no current makes it instantaneously possible to form necessary transmitted light patterns with two dimensional arbitrary shapes (including one dimensional spot) (shutter rings). Since carrying current is electrically performed, behaviors of the pattern change are static and high speed. Moreover, it is not necessary to change luminous flux to be transmitted according to the patterns, and therefore a light source with a constant quantity of light can be used.

The method using the dot matrix-type electro-optical shutter shown in FIG. 12 can change pattern light beams or spot light beams to arbitrary shapes in real time. However, the techniques shown in FIG. 8 to FIG. 12 disables single unit mechanical devices which move and operate such as robots from detecting the presence of obstacles in the 360-degree surrounding area at a time.

Accordingly, an object of the present invention, for solving these issues, is to provide a robot capable of detecting the presence of obstacle in a surrounding area of the movable robot, a transportation method for transporting a transportation target by using the robot, and a guiding method for guiding a guiding target to a destination by using the robot.

### SUMMARY OF THE INVENTION

In order to accomplish the object, the present invention is constituted as shown below.

In order to solve the above issues, according to a first aspect of the present invention, there is provided a robot comprising:

a robot main unit portion;

a projections unit for projecting an annular pattern light beam encircling the robot main unit portion from an upper side of the robot main unit portion to a floor surface around the main unit portion;

an image pickup unit for picking up a projected image of the pattern light beam projected from the projections unit from an upper side of the robot main unit portion;

an image processing device for sensing a displacement of the projected image of the pattern light beam based on the image picked up by the image pickup unit and detecting a height difference portion around the robot main unit portion which is different in height from the floor surface; and

a robot main unit portion driving unit for moving the main unit portion on the floor surface so as to avoid the height difference portion detected by the image processing device or to go toward the height difference portion.

According to a second aspect of the present invention, there is provided the robot as defined in the first aspect, wherein the image processing device calculates a displacement quantity of the projected image of the pattern light beam based on the image picked up by the image pickup unit and calculates a height of the height difference portion from the displacement quantity.

According to a third aspect of the present invention, there is provided the robot as defined in the first aspect, wherein the image processing device determines a presence of the height difference portion if the displacement of the projected image of the pattern light beam exceeds a preset range.

According to a fourth aspect of the present invention, there is provided the robot as defined in the first aspect, wherein

the projections unit comprises:

a light source for generating specified luminous flux;

a dot matrix-type electro-optical shutter for blocking a part of the luminous flux generated from the light source and processing the luminous flux to have an annular pattern light beam; and

a pyramidal reflection unit for reflecting a pattern light beam transmitted through the dot matrix-type electro-optical shutter and projecting the pattern light beam onto the floor surface around the robot main unit portion.

According to a fifth aspect of the present invention, there is provided the robot as defined in the fourth aspect, wherein the dot matrix-type electro-optical shutter is capable of forming a plurality of annular pattern light beams simultaneously and concentrically.

According to a sixth aspect of the present invention, there is provided the robot as defined in the first aspect, wherein the robot main unit portion further comprises an image pickup unit posture control unit for controlling at least either a position of the image pickup unit or an image pickup angle thereof with respect to the robot main unit portion.

According to a seventh aspect of the present invention, there is provided the robot as defined in the first aspect, wherein the robot main unit portion further comprises a ranging sensor for measuring a distance between the robot main unit portion and the height difference portion.

According to an eighth aspect of the present invention, there is provided a transportation method for transporting a transportation target, comprising:

projecting an annular pattern light beam encircling a robot main unit portion from an upper side of the robot main unit portion to a floor surface around the main unit portion;

picking up a projected image of the projected pattern light beam from an upper side of the robot main unit portion;

sensing a displacement of the projected image of the pattern light beam based on the picked up image;

detecting a height difference portion around the robot main unit portion which is different in height from the floor surface; and

moving the main unit portion on the floor surface so as to go toward the detected height difference portion.

According to a ninth aspect of the present invention, there is provided a guiding method for guiding a guiding target to a destination, comprising:

projecting an annular pattern light beam encircling a robot main unit portion from an upper side of the robot main unit portion to a floor surface around the main unit portion;

picking up a projected image of the projected pattern light beam from an upper side of the robot main unit portion;

sensing a displacement of the projected image of the pattern light beam based on the picked up image;

detecting a height difference portion around the robot main unit portion which is different in height from the floor surface; and

moving the main unit portion on the floor surface so as to avoid the detected height difference portion or to go toward the height difference potion.

According to another aspect of the present invention, there is provided the robot as defined in the first aspect, in which the image processing device has a memory for storing a projected image of the pattern light beam in a state that the pattern light beam is projected onto a horizontal floor surface without the presence of the obstacle, as a reference projected image, and

the image processing device applies image subtraction between a projected image of the pattern light beam when the pattern light beam is projected onto the obstacle around the main unit portion and the reference projected image stored in the memory to calculate a difference image as a result of the image subtraction, and senses a displacement of the projected image of the pattern light beam based on the calculated difference image to detect the obstacle.

According to another aspect of the present invention, there is provided the robot as defined in the fourth aspect, in which the dot matrix-type electro-optical shutter is capable of forming a plurality of annular pattern light beams simultaneously and appending information to distinguish a plurality of the pattern light beams to a plurality of the pattern light beams, and the image processing device is capable of distinguishing a plurality of the pattern light beams based on the information.

According to such structure, the projections unit can project the annular pattern light beam encircling the main unit portion from the upper side of the main unit portion toward the floor surface around the main unit portion, the image pickup unit can pick up the projected image of the pattern light beam projected from the projections unit from the upper side of the main unit portion, the image processing device can sense the displacement of the projected image of the pattern light beam based on the image picked up by the image pickup unit and can detect the height difference potion around the robot main unit portion which is different in height from the floor surface.

According to the present invention as described hereinabove, the projections unit can project the annular pattern light beam encircling the main unit portion from the upper side of the main unit portion toward the floor surface around the main unit portion, the image pickup unit can pick up the projected image of the pattern light beam projected from the projections unit from the upper side of the main unit portion, the image processing device can sense the displacement of the projected image of the pattern light beam based on the image picked up by the image pickup unit and can detect the height difference potion around the robot main unit portion which is different in height from the floor surface (e.g., obstacles, persons or uneven spots on the floor surface). Therefore, when, for example, a plurality of height difference portions are simultaneously present around the main unit portion, simultaneously projecting the pattern light beams to these height difference portions from the projections unit makes it possible to determine the presence of these height difference portions at a time.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1A is a perspective view for showing the schematic configuration and obstacle detection operation of a robot in one embodiment of the present invention;

FIG. 1B is a control block diagram for performing operation control of the robot in FIG. 1A;

FIG. 1C is a schematic explanatory view for showing a vertical movement and posture control mechanism of a camera of the robot in FIG. 1A;

FIG. 2A is a view for showing a surrounding pattern projecting system in the robot shown in FIG. 1A;

FIG. 2B is a view for showing the cross section of an entire circumference mirror reflector, a shutter, and a light source in the surrounding pattern projecting system shown in FIG. 2A;

FIG. 3 is a view for showing one example of a picked-up image of the camera;

FIG. 4 is a view for showing image subtraction by an image processing device;

FIG. 5 is a view for showing one example to obtain the height of an obstacle;

FIG. 6A is a view for showing an example of a projected pattern image with a shape different from a projected pattern image in FIG. 1 A;

FIG. 6B is a view for showing an example of a projected pattern image with a shape different from the projected pattern images in FIG. 1A and FIG. 6;

FIG. 7 is a view for showing the case where a plurality of projected pattern images are formed by a dot matrix-type electro-optical shutter;

FIG. 8 is a view for showing the principle of triangulation;

FIG. 9 is a view for showing a method for measuring a distance to a measurement target by the binocular vision method based on the principle of triangulation;

FIG. 10 is a view for showing one example of a method for measuring a distance to a measurement target by the conventional spot projection method;

FIG. 11 is a view for showing one example of a method for measuring a distance to a measurement target by the conventional pattern projection method;

FIG. 12 is a view for showing a measurement method using a conventional dot matrix-type electro-optical shutter;

FIG. 13 is a flow chart for showing the operation of the robot in the embodiment of the present invention;

FIG. 14 is a perspective view for showing the operation for detecting a person in the case where the robot in the embodiment of the present invention is applied to a transportation method for transporting a transportation target;

FIG. 15 is a view for showing one example of a picked up image of a camera in the robot in FIG. 14;

FIG. 16 is a perspective view for showing the operation for detecting a person in the case where the robot in the embodiment of the present invention is applied to a guiding method for guiding a guiding target to a destination;

FIG. 17 is a view for showing one example of a picked up image of a camera in the robot in FIG. 16.

### DETAILED DESCRIPTION OF THE PREFERRED EMBODIMENTS

Before the description of the present invention proceeds, it is to be noted that like parts are designated by like reference numerals throughout the accompanying drawings.

Hereinbelow, the embodiments of the present invention will be described in detail with reference to the drawings.

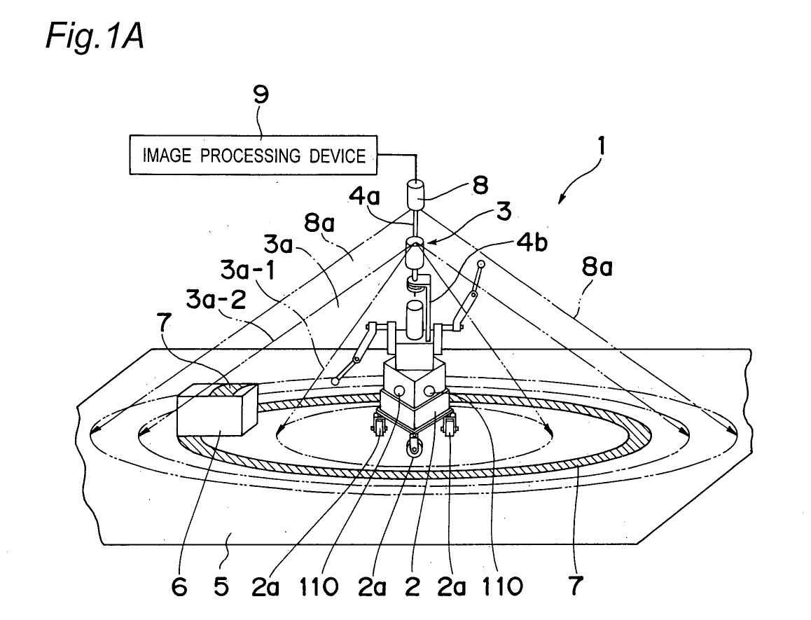

Hereinbelow, description will be given of a robot in one embodiment of the present invention with reference to FIG. 1A to FIG. 7.

As shown in FIG. 1A, a robot 1 in the embodiment of the present invention is composed of: a main unit portion 2 of the robot 1; a surrounding pattern projection system 3 serving as one example of the projections unit and mounted on the upper portion of the main unit portion 2 in the state of being supported by a bracket-shaped projections unit support portion 4b provided to stand on the main unit portion 2, for projecting a continuous or intermittent annular pattern light beam 3a encircling the main unit portion 2 (the inner periphery of the pattern light beam 3a is shown by reference numeral 3a-1 while the outer periphery is shown by reference numeral 3a-2) from the upper side of the main unit portion 2 toward a floor surface 5 around the main unit portion 2 in an oblique direction with respect to the floor surface 5; an omnidirectional or normal camera 8 serving as one example of the image pickup unit and mounted on the upper portion of the surrounding pattern projection system 3 via a rail-type camera support portion 4a provided to stand on the main unit portion 2, for picking up a projected image 7 of the pattern light beam 3a (hereinbelow referred to as a projected pattern image), which is projected from the surrounding pattern projection system 3 onto the floor surface 5 or an obstacle 6, from the upper side of the main unit portion 2; and an image processing device 9 (described in detail later) for detecting the presence of the obstacle 6 based on the image picked up by the camera 8 and measuring the height of the obstacle 6 when the obstacle 6 is present. Reference numeral 8a denotes an image pickup range of the camera 8. Reference numeral 2a denotes four wheels attached to the main unit portion 2 for allowing the robot 1 to move.

In FIG. 1B, reference numeral 101 denotes a robot main unit portion driving unit for controlling movement of the robot main unit portion 2, and the robot main unit portion driving unit 101 is constructed by two left-hand and right-hand motors 101L, 101R for independently rotating, for example, opposite two wheels 2a, 2a among four wheels 2a in positive and negative directions and a driver 101D for controlling drive of these left-hand and right-hand motors 101L, 101R. Reference numeral 100 denotes a control unit for controlling operations of a dot matrix-type electro-optical shutter 10 and a light source 11 of the surrounding pattern projection system 3, the camera 8, the image processing device 9, an image processing device memory 9a, the driver 101D of the robot main unit portion driving unit 101, (a later-described vertical drive control unit 8A, and/or a ranging sensor 110, which are provided where necessary), respectively.

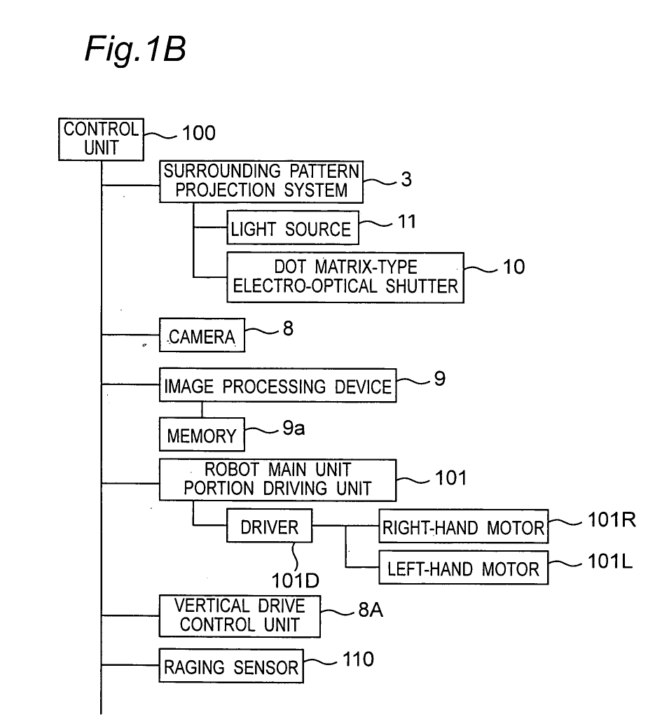

The surrounding pattern projection system 3 has, as shown in FIG. 2A, a dot matrix-type electro-optical shutter 10 such as a liquid crystal panel, a light source 11 for projecting specified luminous flux from the lower side toward the shutter 10, and an entire circumference mirror reflector 12 serving as one example of the pyramidal reflection unit for reflecting light beams passing the shutter 10 from the lower side to the upper side, toward the floor surface 5.

The shutter 10 can block an arbitrary part of the shutter 10 under the control of the control unit 100 so as to form, for example, an annular or circular arc pattern in real time, and when luminous flux projected from the light source 11 passes the shutter 10 under the control of the control unit 100, the luminous flux is processed to an annular or a circular arc pattern light beam 3a. It is to be noted that in FIGS. 1A to 4, description is give of the case where the pattern light beam 3a is annular.

As shown in FIG. 2A and FIG. 2B, the entire circumference mirror reflector 12 is in a funnel shape, i.e., an inverted circular conic shaped, and its side face 12a is formed into a mirror surface in a concave state. With this, the pattern light beam 3a passing the shutter 10 from the lower side to the upper side can be mirror-reflected by the entire circumference of the side face 12a of the entire circumference mirror reflector 12, and the annular pattern light beam 3a around the entire circumference mirror reflector 12 can be projected onto the floor surface 5 surrounding the robot 1 in an oblique direction with respect to the floor surface 5 so as to encircle the robot 1.

With such structure, under the control of the control unit 100, the respective devices or members operate to detect the presence of the obstacle 6 in the surrounding area of the robot 1 as shown below, and if the obstacle 6 is present in the surrounding area of the robot 1, a height of the obstacle 6 from the floor surface 5 is measured.

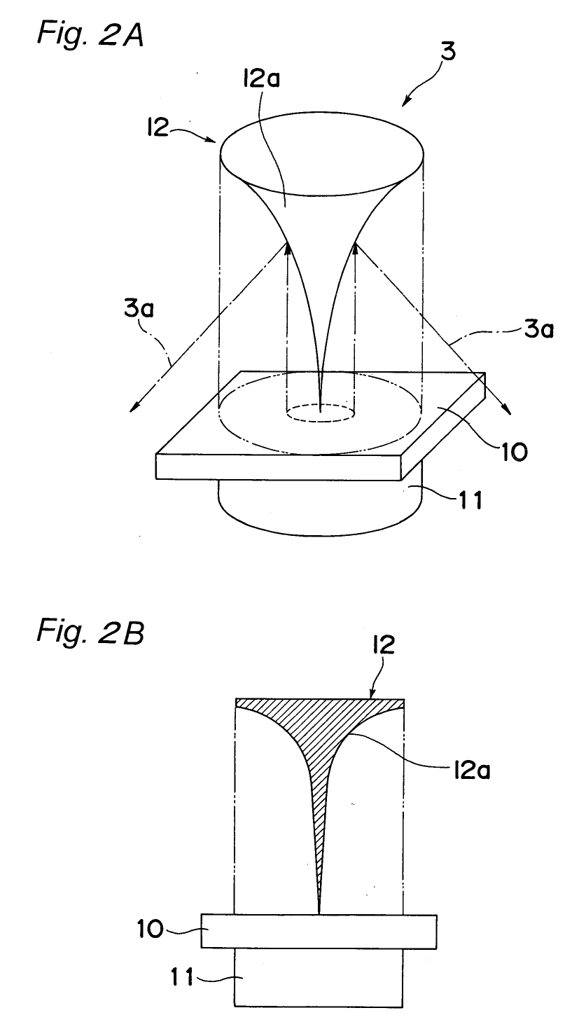

More particularly, first, when the floor surface 5 around the robot 1 is almost horizontal and the obstacle 6 is not present around the robot 1, the pattern light beam 3a is projected onto the floor surface 5, an image of the floor surface 5 onto which the pattern light beam 3a is projected is picked up by the camera 8, the image is inputted into the image processing device 9, and a projected pattern image 7 of the pattern light beam 3a is stored in the memory 9a as a reference projected image (hereinbelow referred to as a reference projected pattern image) 14 (see FIG. 4). Moreover, the image at that time is stored in the memory 9a as a reference image 15 (see FIG. 4).

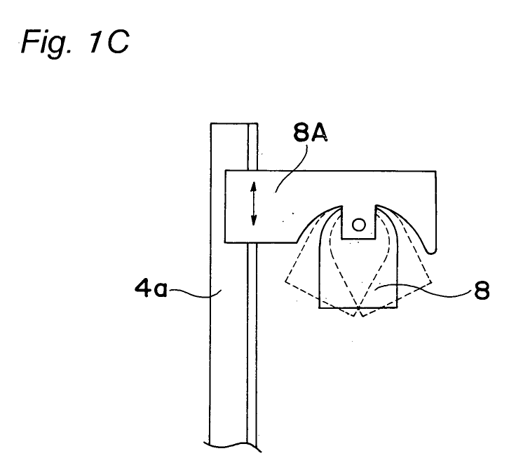

Then, once the reference image 15 is stored in the memory 9a, the pattern light beam 3a is projected onto the surrounding area of the robot 1 by the surrounding pattern projection system 3, and while the robot 1 is automatically moved, an image of the floor surface 5 around the robot 1 including the pattern light beam 3a is picked up by the camera 8 and sensing of the obstacle 6 present in the surrounding area of the robot 1 is started. Herein, a picked up image 13 in the case where the obstacle 6 is present in the surrounding area of the robot 1 as shown in FIG. 1A, for example, is shown in FIG. 3.

Normally, when the obstacle 6 is not present in the surrounding area of the robot 1, the projected pattern image 7 of the pattern light beam 3a takes an annular shape identical to the reference projected pattern image 14 as described above. However, when the obstacle 6 is present in the surrounding area of the robot 1, the pattern light beam 3a is projected onto the floor surface 5 in the oblique direction and the obstacle 6 onto which the pattern light beam 3a is projected has a height, as a result of which a portion 7a of the pattern light beam 3a projected onto the obstacle 6 in the projected pattern image 7 is displaced toward the center of the picked up image 13 compared to the portion 7b of the pattern light beam 3a projected onto the floor surface 5 as shown in FIG. 3.

By applying image processing to the picked up image 13 by the image processing device 9, it is recognized that the portion 7a in the projected pattern image 7 is displaced from the portion 7b toward the center of the picked up image 13, and it is determined that the obstacle 6 is present in the surrounding area of the robot 1.

More specifically, with use of image processing device 9, as shown in FIG. 4, pattern matching is performed to compare the picked up image 13 and the stored reference image 15. More particularly, at the time of the pattern matching, if the floor surface 5 is horizontal, then the projected pattern image 7 shows no change no matter where the robot 1 moves, whereas if the pattern light beam 3a is projected onto a portion which is different in height from the floor surface 5, i.e., onto the obstacle 6, then a portion of the pattern light beam 3a projected onto the obstacle 6 in the projected pattern image 7 is displaced toward the center of the picked up image 13 as described above. Therefore, image-subtraction of the reference image 15 from the picked up image 13 makes it possible to obtain a difference image 16 presenting a portion of the picked up projected pattern image 7 displaced from the reference projected pattern image 14, i.e., the portion 7a of the pattern light beam 3a projected onto the obstacle 6 in the projected pattern image 7.

Thus, from the result of the image subtraction of the picked up image 13 and the reference image 15, an unmatched portion between the reference projected pattern image 14 and the projected pattern image 7 on the difference image 16 is a region (image) composed of a batch of numerical values other than 0 (zero), and therefore by detecting the region, and then, the presence of the obstacle 6 in the surrounding area of the robot 1 can be detected. Therefore, even when, for example, a plurality of the obstacles 6 are present on the floor surface 5 in the surrounding area of the robot 1, if the pattern light beam 3a can be projected onto these obstacles 6, then these obstacles 6 can be detected all at once.

Further in this step, calculating the quantity, that is, calculating how much the portion 7a of the pattern light beam 3a projected onto the obstacle 6 in the projected pattern image 7 is displaced toward the center of the picked up image 13 from the reference projected pattern image 14 makes it possible to determine the height of the obstacle 6 from the relation between the displacement quantity and the height of the obstacle 6 from the floor surface 5 based on the fact that the pattern light beam 3a is projected onto the floor surface 5 in the oblique direction.

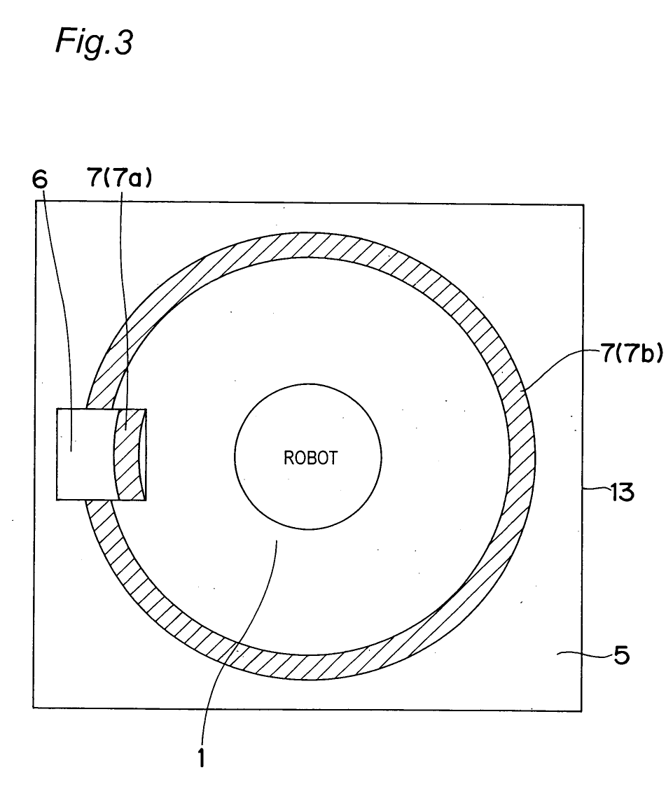

More specifically, as shown in FIG. 5, when an inclined angle of the pattern light beam 3a projected from the surrounding pattern projection system 3 with respect to the vertical direction is θ, and a displacement quantity between the reference projected pattern image 14 and the portion 7a of the pattern light beam 3a projected onto the obstacle 6 in the projected pattern image 7 is s, a height h of the obstacle 6 can be calculated from h·tan θ=s.

Therefore, for example, even if a plurality of the obstacles 6 are present in the surrounding area of the robot 1, calculating how much the projected pattern image 7 of the pattern light beam 3a projected onto these obstacles 6 is displaced from the reference projected pattern image 14 from the result of the image subtraction makes it possible to calculate the heights of these obstacle 6 from the floor surface 5 all at once.

Moreover, during the detection of the displacement quantity, the unevenness not large enough to disturb the movement of the robot 1 is not necessarily determined as the obstacle 6 of the robot 1. The unevenness not large enough to disturb the movement of the robot 1 refers to, for example, braille blocks (studded paving blocks to aid the blind) placed on the floor surface 5 or small projections or depressions thereon. Therefore, a displacement tolerance may be set as a preset range, and if the detected displacement quantity is within the displacement tolerance, then the displacement quantity may be determined to be zero so that the movement of the robot 1 is executed based on the assumption that the obstacle 6 is not present.

As one example, if the outer periphery of the annular pattern light beam 3a is two meters in diameter and the annular pattern light beam 3a is projected onto the floor surface 5 at an inclined angle of 45 degrees with respect to the floor surface 5, the projections or depressions with a height of not more than 10 cm are nor regarded as the obstacle 6, and a displacement on the image not larger than 25 pixels corresponding to the projections or depressions with a height of not more than 10 cm is handled as within the displacement tolerance.

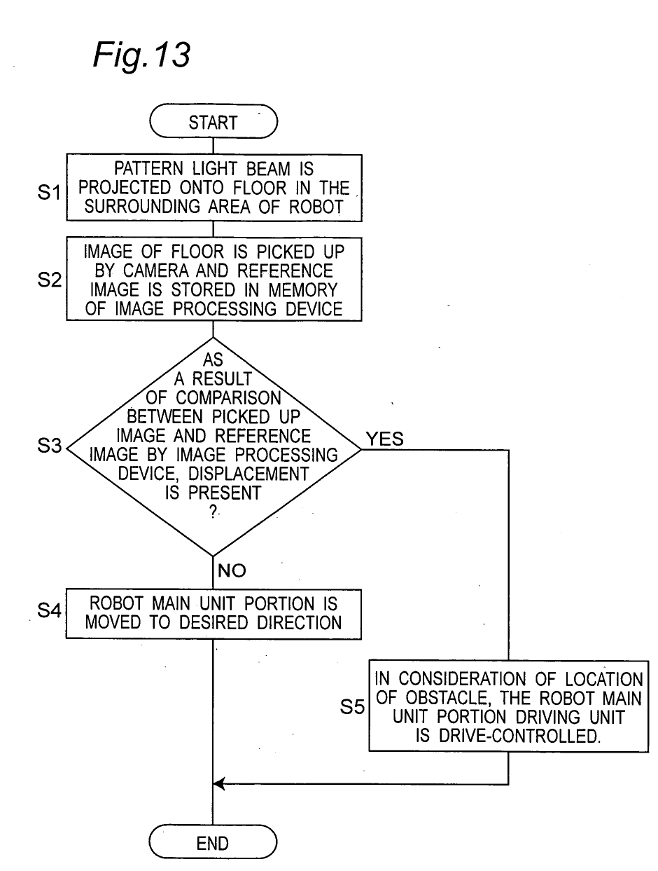

More specifically, FIG. 13 shows a flow chart of the obstacle detection operation of the thus-structured robot. The obstacle detection operation is executable both before starting the movement of the robot 1 and during movement of the robot 1 under the drive control of the robot main unit portion driving unit 101.

First, in step S1, the pattern light beam 3a is projected onto the floor surface 5 in the surrounding area of the robot 1.

Next, in step S2, an image of the floor surface 5 onto which the pattern light beam 3a is projected is picked up by the camera 8, and the reference image 15 is stored in the memory 9a of the image processing device 9.

Next, in step S3, pattern matching is performed to compare the picked up image 13 and the reference image 15 by the image processing device 9. If the picked up image 13 and the reference image 15 match (match in the tolerance range), then it is determined that the obstacle 6 is not present and the procedure proceeds to step S4. If the picked up image 13 and the reference image 15 do not match and a displacement is present (a displacement beyond the tolerance range is present), then it is determined that the obstacle 6 is present, and the procedure proceeds to step S5.

Next, in step S4, the left-hand and right-hand motors 101L, 101R of the robot main unit portion driving unit 101 are driven to move the robot main unit portion 2 to a desired direction, and then, the procedure returns to step S1.

In step S5, in consideration of the location of the obstacle 6, the robot main unit portion driving unit 101 is drive-controlled by the control unit 100, and then the procedure returns to step S1.

More specifically in step S5, in the case where, for example, the robot 1 is moved so as to avoid the location of the obstacle 6, the robot main unit portion driving unit 101 is drive-controlled so as to avoid the location of the obstacle 6.

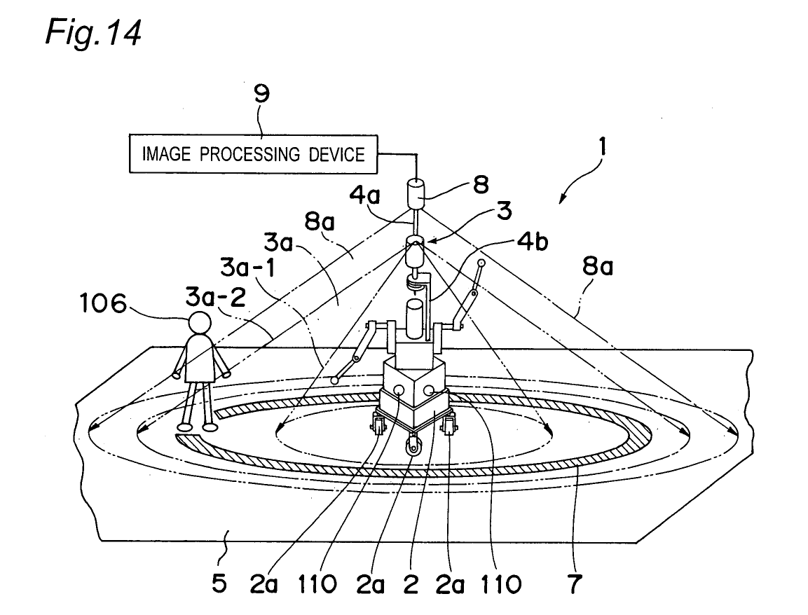

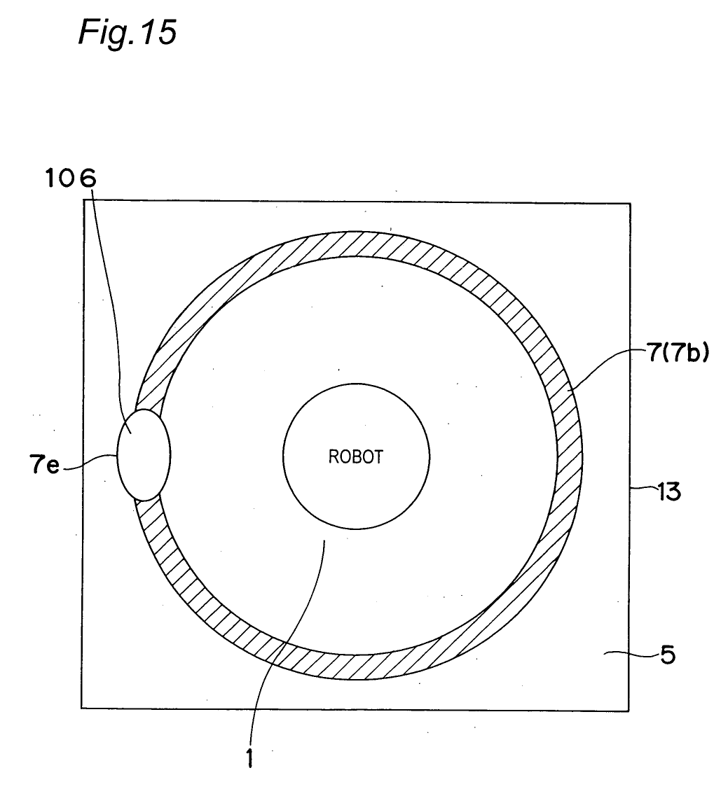

Moreover, in the case where the robot is used as a robot which follows a person while transporting a package with the package placed on the robot, which serves as one example of the transportation target for implementing the transportation method for transporting the transportation target, in the state of being put on the robot, the robot 1 needs to be moved so as to follow the location of a person 106 that is a substitute of the obstacle 6 serving as one example of the height difference portion as shown in FIG. 14, and in this case, the robot main unit portion driving unit 101 is drive-controlled so as to go toward the location of the person 106. Herein, as shown in FIG. 15, in the picked up image of the camera, a portion 7e where the person 106 is present is in the state that a part of the portion 7b projected onto the floor surface 5 is almost missing.

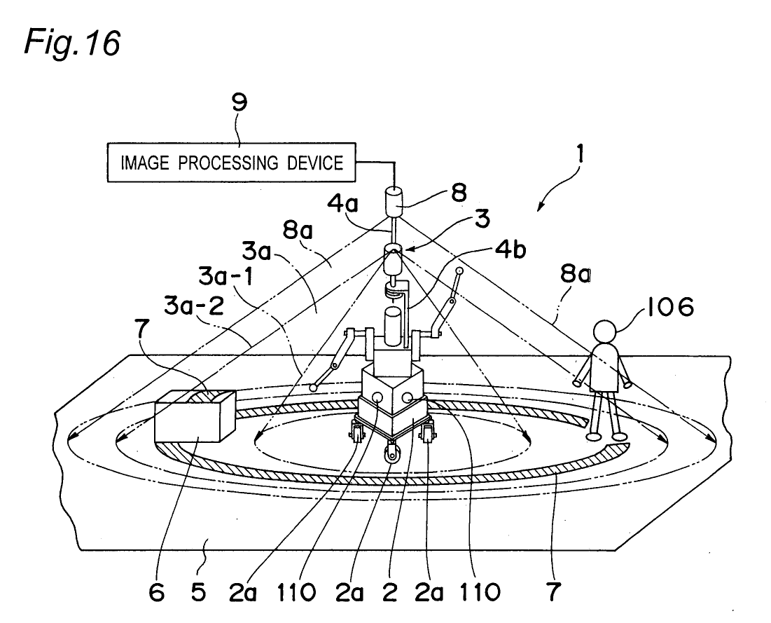

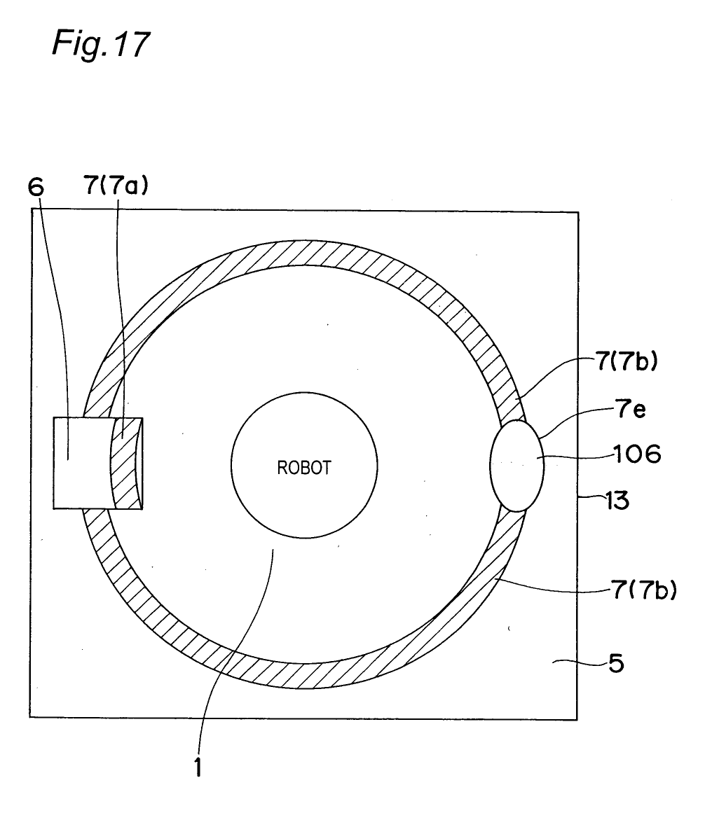

On the contrary to this, in the case where the robot is used as a guiding robot for guiding a person which serves as one example of the guiding target for implementing the guiding method for guiding a guiding target to a destination, as shown in FIG. 16, it is necessary to detect the obstacle 6 on the front side of the robot (e.g., in the 180-degree range on the front side of the robot) and it is necessary to confirm that the person 106, that is a substitute of the obstacle 6 serving as one example of the height difference portion, follows the robot on the rear side of the robot (e.g., in the 180-degree range on the rear side of the robot) while the robot 1 is moved, and in this case, the robot main unit portion driving unit 101 is drive-controlled while the constant presence of the person 106 on the rear side of the robot is maintained. Herein as shown in FIG. 17, in the picked up image of the camera, a portion 7e where the person 106 is present on the rear side of the robot is in the state that a part of the portion 7b of the pattern light beam 3a projected onto the floor surface 5 is almost missing.

According to the embodiment, the obstacle 6 in the surrounding area of the main unit portion 2 can be detected by: projecting by the surrounding pattern projection system 3 serving as one example of the projections unit, an annular pattern light beam 3a encircling the main unit portion 2 from an upper side of the robot main unit portion 2 to the floor surface 5 around the main unit portion 2 in an oblique direction with respect to the floor surface 5; picking up by the camera 8 serving as one example of the image pickup unit, a projected image of the pattern light beam 3a projected from the surrounding pattern projection system 3 from the upper side of the main unit portion 2; and sensing by the image processing device 9, the displacement of the projected image of the pattern light beam 3a based on the picked up image picked up by the camera 8, the displacement being generated when the pattern light beam 3a is projected onto a portion of the obstacle 6 around the main unit portion 2 which is different in height from the floor surface 5. Therefore, even when, for example, a plurality of the obstacles 6 are simultaneously present in the surrounding area of the main unit portion 2, simultaneously projecting the pattern light beam 3a onto these obstacles 6 by the surrounding pattern projection system 3 allows the presence of these obstacles 6 to be determined all at once. Therefore, in the robot 1 which is moving by driving of the left-hand and right-hand motors 101L, 101R of the robot main unit portion driving unit 101 under the control of the control unit 100, it becomes possible to detect the presence of the obstacle 6 in the surrounding area of the robot 1, which makes it possible to use the robot as the robot 1 which operates in the environment where persons are present around the robot 1.

It is to be noted that in the case of the robot which follows a person, when the picked up image 13 and the reference image 15 are compared in the step S4, a detection range of, for example, about 45 degrees around the position where a person, the height difference portion, is sensed in the previous comparison is set in advance, and then the comparison between the picked up image 13 and the reference image 15 are performed only in this preset range, so that comparison processing can be performed more swiftly and easily. This is because it can be considered that on the assumption that when the robot follows a person, the person does not suddenly move crosswise, detecting the detection range of, for example, about 45 degrees around the position where the person is detected normally ensures that the robot can sufficiently follow the person.

Moreover, in this structure, using the dot matrix-type electro-optical shutter 10 in the surrounding pattern projection system 3 allows the pattern of the pattern light beam 3a to be changed in real time.

It is to be noted that as the dot matrix-type electro-optical shutter 10, liquid crystal devices are effective at the present time. In addition, by using computer terminal display devices such as plasma panel PLZT (Piezo-electric Lanthanum-modified lead Zirconate Titanate) devices, shutters with higher-speed and high SN ratio can be expected.

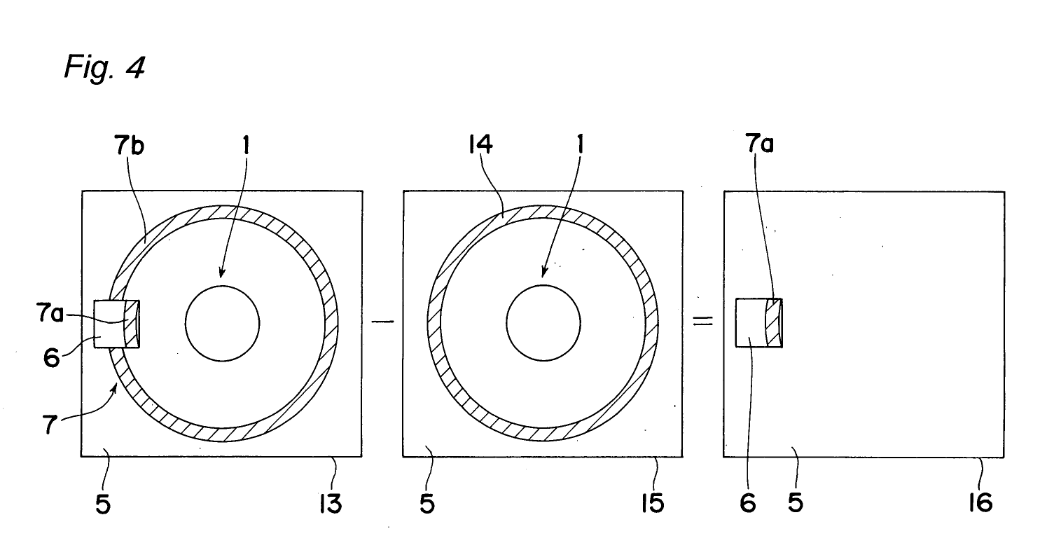

Moreover, in this structure, description has been given of the case where the shutter 10 forms a pattern in which the projected pattern image 7 is formed into a continuous annular pattern. However, the present invention is not limited thereto, and it is acceptable to form, for example, a pattern which is formed into an annular projected pattern image 7c drawn by a broken line as shown in FIG. 6A as a reference image 13A. Moreover, it is also acceptable to form an oval-shaped pattern as a reference image 13B, the oval-shaped pattern being formed by combining two semicircular arc-shaped projected pattern images 7d and linear projected pattern images 7d as shown in FIG. 6B. Thus, as with the previous case, it becomes possible to detect the obstacle 6 which is a specified distance away from the robot 1.

Further, in the structure, forming a plurality of annular projected pattern images 7 with different diameters simultaneously and concentrically by the dot matrix-type electro-optical shutter 10 causes a displacement in a portion of the light beam projected on the obstacle 6 in each projected pattern image 7. Consequently, by recognizing the displacement portion(s) and the displacement quantity(s) in each of these projected pattern images 7, it becomes possible to recognize, for example, a portion with a wide distance between the displaced portions in a plurality of the projected pattern images 7 and a portion with a narrow distance therebetween, while in the case where the projected pattern image 7 is a single image, then it becomes possible to check the presence and the height of the obstacle 6 as well as to check the size and the shape of the obstacle 6 in detail.

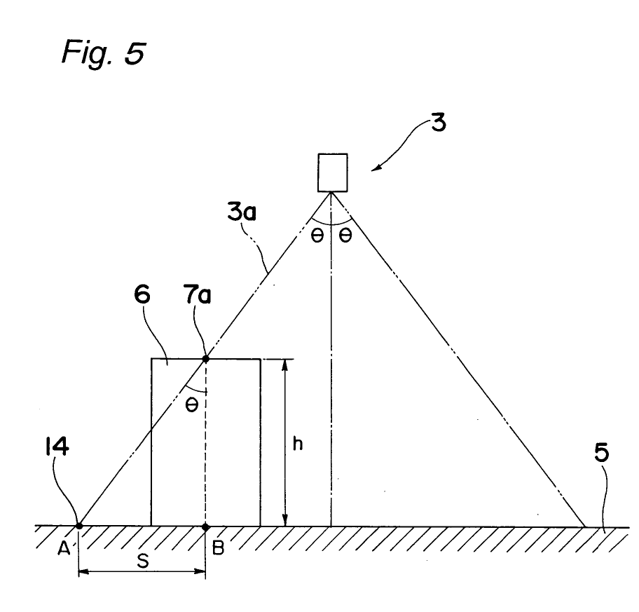

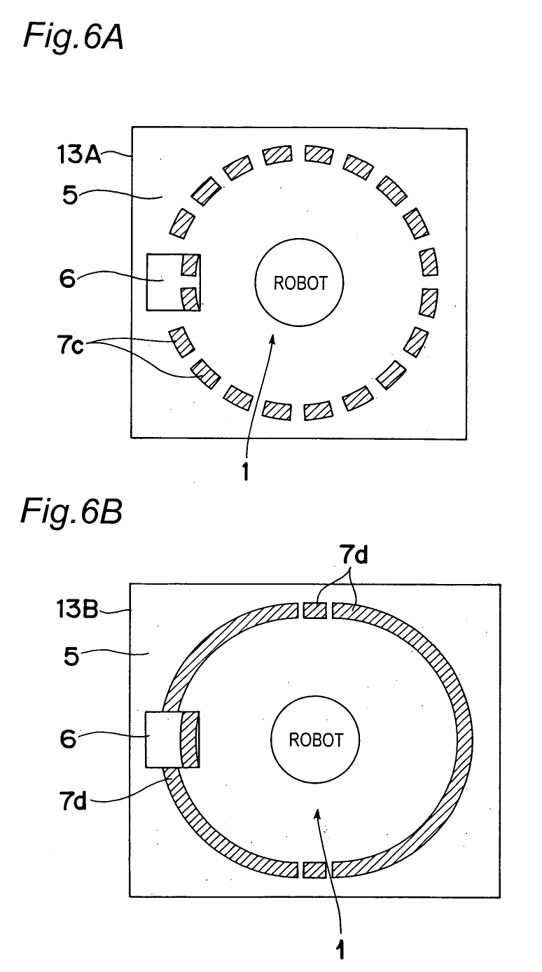

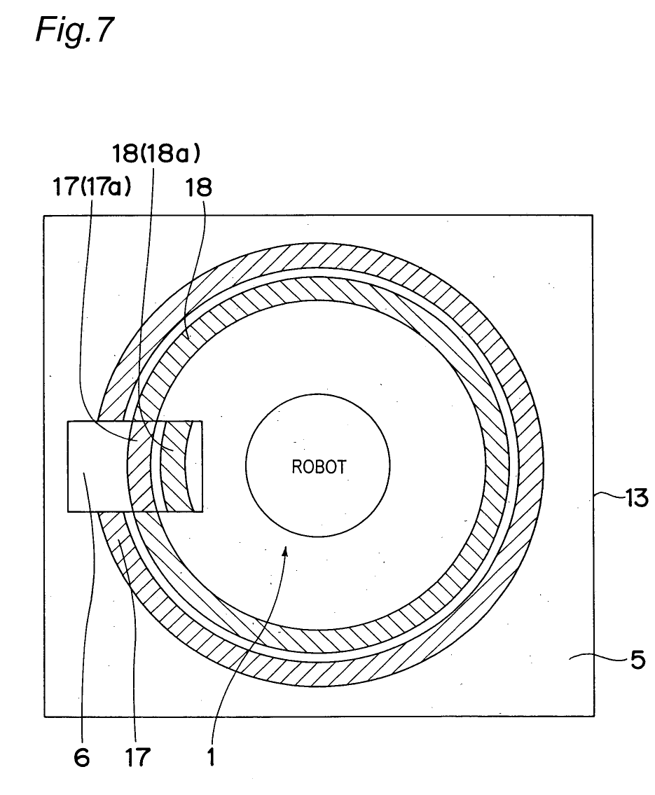

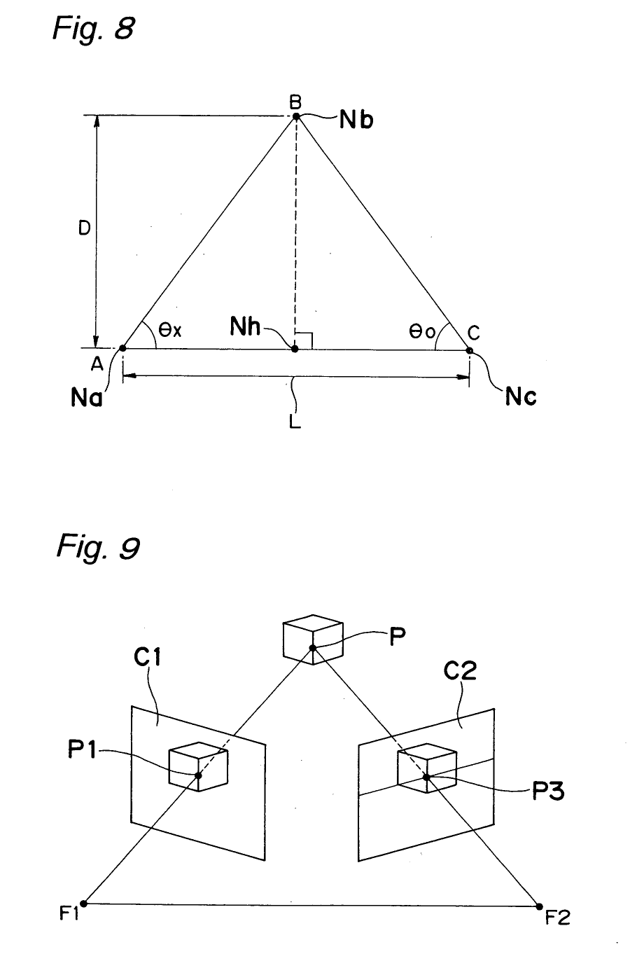

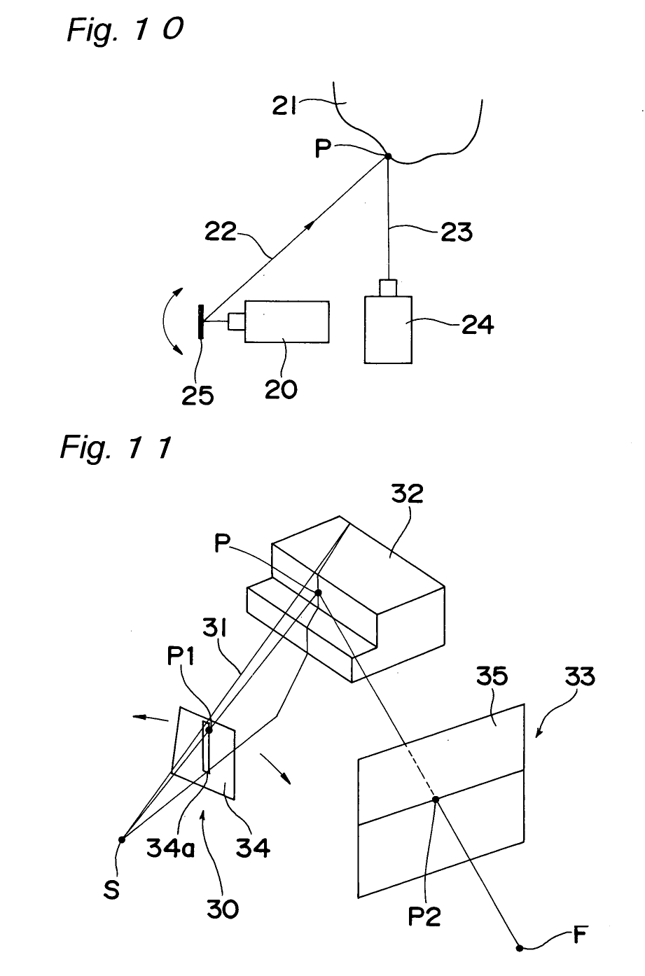

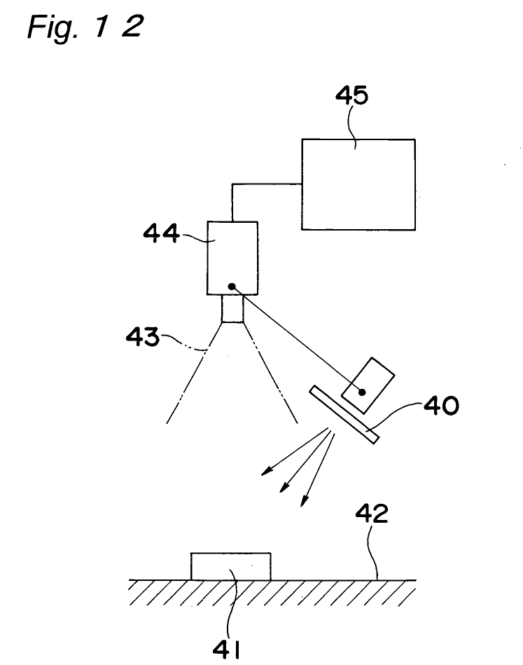

In this case, a plurality of these displacement portions are displaced toward the center of the picked up image 13 as described above. Consequently, as shown in FIG. 7, for example, in the case where an annular projected pattern image 17 and an annular projected pattern image 18 with a smaller diameter disposed inside the projected pattern image 17 are present simultaneously and concentrically, a portion where the obstacle 6 is present in the projected pattern images 17, 18 is cut off by the obstacle 6, and as a result, a gap is generated in these portions. In some cases, a displacement portion 17a in the projected pattern image 17 is fitted into the gap in the annular projected pattern image 18.

Consequently, in an image picked up by the camera 8, the annular projected pattern image 18 appears to be continuous in circumferential direction, and it is hard to distinguish between the displacement portion 17a in the projected pattern image 17 and the annular projected pattern image 18.

However, by appending information to distinguish each other to the projected pattern image 17 and the annular projected pattern image 18 in advance by the dot matrix-type electro-optical shutter 10, and inputting the information attached to the respective projected pattern images 17, 18 into the image processing device 9, the image processing device 9 can distinguish the portion 17a of the projected pattern image 17 and the annular projected pattern image 18 based on the information. By this, the displacement portion and the displacement quantity in each of the projected pattern images 17, 18 can be recognized so that the size and the shape of the obstacle 6 can be checked. It is to be noted that reference numeral 18a denotes a displacement portion of the annular projected pattern image 18.

It is to be understood that the present invention is not limited to the embodiments and is capable to be embodied in other various aspects.

For example, as shown in FIG. 1C, the camera 8 may be movably mounted on a camera support portion 4a via a camera drive unit 8A incorporating a motor and the like, and serving as one example of the vertical drive control unit (or serving as one example of the image pickup unit posture control unit), and by driving the camera drive unit 8A, the camera 8 may be moved in vertical direction along the camera support portion 4a, while the camera 8 may be mounted on the camera drive unit 8A in an inclinable way. In such arrangement, driving of the camera drive unit 8A allows the camera 8 to move in vertical direction by which the position of the camera 8 with respect to the robot main unit portion 2 can be adjusted, while mounting the camera 8 on camera drive unit 8A in an inclined state with respect to the camera drive unit 8A at a desired angle allows control of the posture of the camera 8 (in other words, image pickup angle), which allows the viewing range to be variable to a long-range surrounding, a short-range surrounding, and a front-oriented surrounding.

Further, a raging sensor 110 capable of measuring a distance surrounding the robot main unit portion 2 may be mounted on, for example, each of the front, rear, left-hand, and right-hand side faces of the robot main unit portion 2, and may be connected to the control unit 100, a distance between the detected obstacle 6 around the main unit portion 2 and the main unit portion 2 may be measured by the raging sensors 110 capable of measuring the surrounding distances, and information on the obstacle 6 obtained in advance by the image processing device 9 may be combined to distance information on the vicinity of the obstacle obtained by the distance measurement so as to detect the position and the direction of the obstacle 6 with higher accuracy.

By properly combining the arbitrary embodiments of the aforementioned various embodiments, the effects possessed by the embodiments can be produced.

### INDUSTRIAL APPLICABILITY

According to the robot in the present invention, it becomes possible to detect the presence of obstacles in the surrounding area of the robot, which allows the robot to be used as the robot operating in the environment where a person(s) is present around the robot. Therefore, the robot of the present invention is effective for the transportation method for transporting a transportation target in the state of being put on the robot by using the robot, and the guiding method for guiding a guiding target such as a person to a destination by using the robot.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A robot comprising:
a robot main unit portion;
a projections unit for projecting an annular pattern light beam encircling the robot main unit portion from an upper side of the robot main unit portion to a floor surface around the main unit portion;
an image pickup unit for picking up a projected image of the pattern light beam projected from the projections unit from an upper side of the robot main unit portion;
an image processing device for sensing a displacement of the projected image of the pattern light beam based on the image picked up by the image pickup unit and detecting a height difference portion around the robot main unit portion which is different in height from the floor surface; and
a robot main unit portion driving unit for moving the main unit portion on the floor surface so as to avoid the height difference portion detected by the image processing device or to go toward the height difference portion.

2. The robot as defined in claim 1, wherein the image processing device calculates a displacement quantity of the projected image of the pattern light beam based on the image picked up by the image pickup unit and calculates a height of the height difference portion from the displacement quantity.

3. The robot as defined in claim 1, wherein the image processing device determines a presence of the height difference portion if the displacement of the projected image of the pattern light beam exceeds a preset range.

4. The robot as defined in claim 1, wherein
the projections unit comprises:
a light source for generating specified luminous flux;
a dot matrix-type electro-optical shutter for blocking a part of the luminous flux generated from the light source and processing the luminous flux to have an annular pattern light beam; and
a pyramidal reflection unit for reflecting a pattern light beam transmitted through the dot matrix-type electro-optical shutter and projecting the pattern light beam onto the floor surface around the robot main unit portion.

5. The robot as defined in claim 4, wherein the dot matrix-type electro-optical shutter is capable of forming a plurality of annular pattern light beams simultaneously and concentrically.

6. The robot as defined in claim 1, wherein the robot main unit portion further comprises an image pickup unit posture control unit for controlling at least either a position of the image pickup unit or an image pickup angle thereof with respect to the robot main unit portion.

7. The robot as defined in claim 1, wherein the robot main unit portion further comprises a ranging sensor for measuring a distance between the robot main unit portion and the height difference portion.

8. A transportation method for transporting a transportation target, comprising:
projecting an annular pattern light beam encircling a robot main unit portion from an upper side of the robot main unit portion to a floor surface around the main unit portion;
picking up a projected image of the projected pattern light beam from an upper side of the robot main unit portion;
sensing a displacement of the projected image of the pattern light beam based on the picked up image;
detecting a height difference portion around the robot main unit portion which is different in height from the floor surface; and
moving the main unit portion on the floor surface so as to go toward the detected height difference portion.

9. A guiding method for guiding a guiding target to a destination, comprising:
projecting an annular pattern light beam encircling a robot main unit portion from an upper side of the robot main unit portion to a floor surface around the main unit portion;
picking up a projected image of the projected pattern light beam from an upper side of the robot main unit portion;
sensing a displacement of the projected image of the pattern light beam based on the picked up image;
detecting a height difference portion around the robot main unit portion which is different in height from the floor surface; and
moving the main unit portion on the floor surface so as to avoid the detected height difference portion or to go toward the height difference potion.
